(19) United States
(12) Patent Application Publication
(10) Pub. No.: US 2010/0084788 A1
(43) Pub. Date: Apr. 8, 2010

(54) MOULD FOR COMPRESSION-FORMING A CAPSULE WITH HINGED LID

(75) Inventors: Zeno ZUFFA, Bologna (IT); Fiorenzo Parrinello, Bologna (IT)

Correspondence Address: BROWDY AND NEIMARK, P.L.L.C.;624 NINTH STREET, NW, SUITE 300, WASHINGTON, DC, 20001-5303, US

(73) Assignee: SACMI COOPERATIVA MECCANICI IMOLA SOCIETA' COOPERA, Imola, (Bologna) (IT)

(21) Appl. No.: 11/995,666

(22) PCT Filed: Jun. 16, 2006
(86) PCT No.: PCT/EP2006/005850

§ 371 Date: Jan. 14, 2008

(30) Foreign Application Priority Data
Jul. 22, 2005 (IT) RE2005A00090

(51) Int. Cl. B29C 43/14; B29C 43/58; B29C 43/52

(52) U.S. Cl. 264/296; 425/412; 425/144

(57) ABSTRACT

Method for forming an item through compression-moulding having an asymmetrical section with differentiated volumes and thicknesses, comprising the steps of introducing a dose of semi-liquid resin into the recess of a mould, inserting a plunger in said recess to create the interspace intended to be occupied by the material pushed by the plunger, removing said plunger and withdrawing the item that stays stuck to the plunger or to the recess, where the interspace intended for the forming of the item is created in two successive steps, the first comprising the insertion of a first plunger into the recess, and the second comprising the action of a second plunger that acts in a portion (accumulation chamber) of the interspace created by the insertion of the first plunger, completing the creation of the interspace in which the item is formed.

### TECHNICAL FIELD

The present invention concerns the forming through compression-moulding of an item having an asymmetrical section with differentiated thicknesses, and comprising portions of different volume connected by a portion with thin section.

A typical example of these items are bottle closures, made from synthetic material, of the type that comprises a capsule intended to be fixed to the neck of the bottle equipped with a hole for dispensing the product, and a lid possibly equipped with a cap, which is connected to the capsule by a narrow section of material, and having the function of a hinge.

More specifically, the invention concerns closures of the aforementioned type in which the narrow section has a configuration such as to give them a bi-stable position respectively in closed and open position of the lid.

The following description shall refer to closures of the type defined above which are formed by compression-moulding of thermoplastic resins like polyethylene, polypropylene and the like, also intending to refer to items stated above different to closures.

### BACKGROUND ART

Closures of this type are illustrated in US patent application published with No. US 2004/0169307 to Seaquist Closure Foreign Inc.

The aforementioned document illustrates a method that is intended to overcome the problem of forming through compression-moulding items of irregular and asymmetrical shape, having parts with even very different volumes connected by thin sections, like for example the closures mentioned in the preamble.

The asymmetric and irregular shape of the item to be moulded creates problems deriving from the difficulty that the semi-liquid material has sliding regularly and easily in the interspace limited by the plunger going down in the recess of the mould.

As a consequence of the irregular sliding of the material the filling of the aforementioned interspace is difficult or incomplete, or the regularity of the thicknesses of the formed item is defective.

The problem is particularly serious in the moulding of closures mentioned in the preamble, in which the thicknesses are highly differentiated, particularly at the hinge that is necessarily very thin.

The process described in the aforementioned document is intended to solve the problem thanks to the special configuration of the dose of semi-liquid material fed to the recess of the mould, a configuration that mirrors the irregularities of the section of the item providing differentiated amounts of material for the various portions of the interspace; the larger amounts are provided for the portions of greater volume and vice-versa, so that the sliding of material intended to fill the interspace between recess of the mould and plunger is as homogeneous as possible.

The need to obtain doses of material with differentiated sections, and above all the need to feed said doses with a certain orientation into the recess of the mould, constitutes a serious limitation to the execution of the process.

### DISCLOSURE OF INVENTION

The purpose of the present invention is to eliminate the difficulties that the prior art suffers from, providing a process for forming items with asymmetric section, like closures equipped with dispenser and hinged lid, starting from a dose of thermoplastic material having a configuration independent of the section of the item to be formed.

Said purpose is accomplished according to the finding by a process in which the creation of the interspace for forming the item through compression-moulding is left to the successive action of a first main plunger and of a second secondary plunger that acts in a provisional accumulation chamber of the material communicating with the interspace created by the introduction of the main plunger into the recess of the mould.

Said accumulation chamber is in communication with the recess of the mould, and the second plunger acts in it. The invention also comprises the mould suitable for carrying out the method.

Said mould according to the finding comprises a forming interspace defined, in collaboration with the recess of the mould, by a first plunger that is introduced into the recess of the mould, and by a second plunger that is introduced into an accumulation chamber communicating with the recess of the mould.

### BRIEF DESCRIPTION OF DRAWINGS

The advantageous features and the constructive and functional characteristics of the invention shall become clear from the following detailed description, illustrated by the figures of the attached tables of drawings that refer to a preferred embodiment given as a non-limiting example.

FIG. 1 shows the mould according to the finding in partially closed position sectioned in a plane parallel to the axis.

FIG. 2 is an enlarged portion of FIG. 1.

FIG. 3 shows the section III-III indicated in FIG. 2 without the parts in view.

FIG. 4 shows the mould open before the start of the cycle.

FIG. 5 is FIG. 2 in the exact position with respect to reference line R of the heights of the various parts of the mould.

FIGS. 6 to 16 shows the position of the parts of the mould in the various steps of the moulding, relative to the reference line.

FIGS. 10A to 14A show a component of the mould seen in plan in the various steps of the moulding, arranged below the corresponding FIGS. 10 to 14.

FIG. 17 shows a perspective view of the closure formed with the mould of the previous figures.

FIG. 18 shows the section XVIII-XVIII of FIG. 17.

FIG. 19 shows the partial section XIX-XIX of FIG. 18.

FIGS. 20 and 21 show an enlarged detail of the various positions of some parts of the mould in different operating positions.

FIG. 22 shows the detail of some thermoregulation channels.

FIG. 23 shows a perspective view of a step of removing the item from the mould.

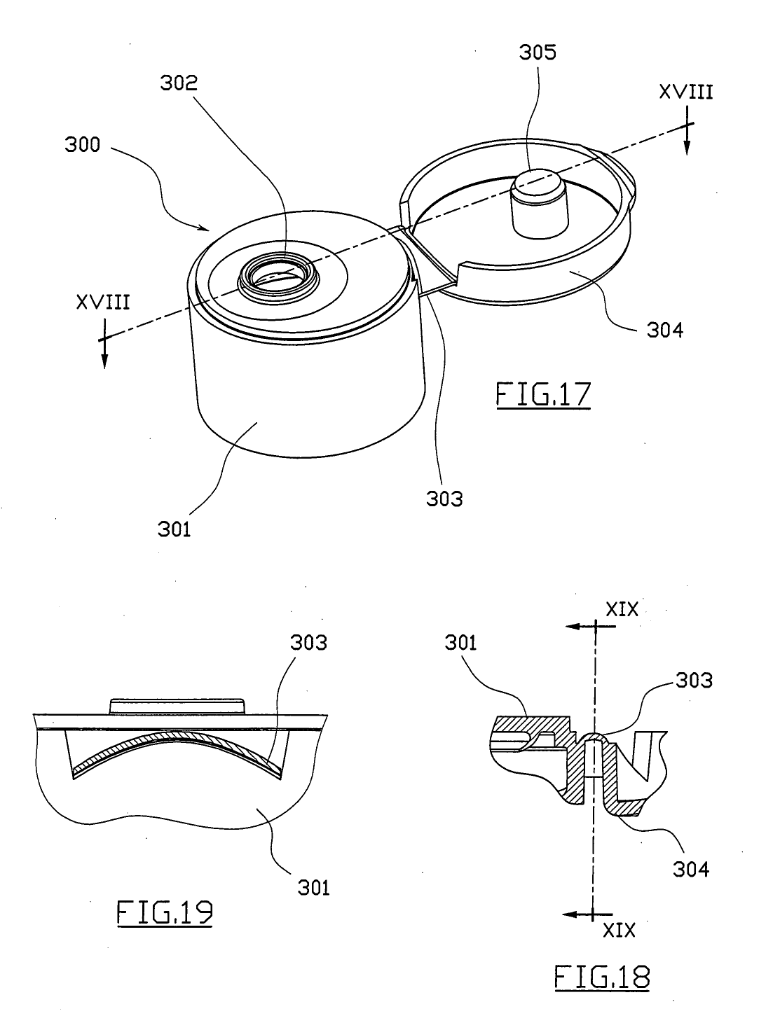

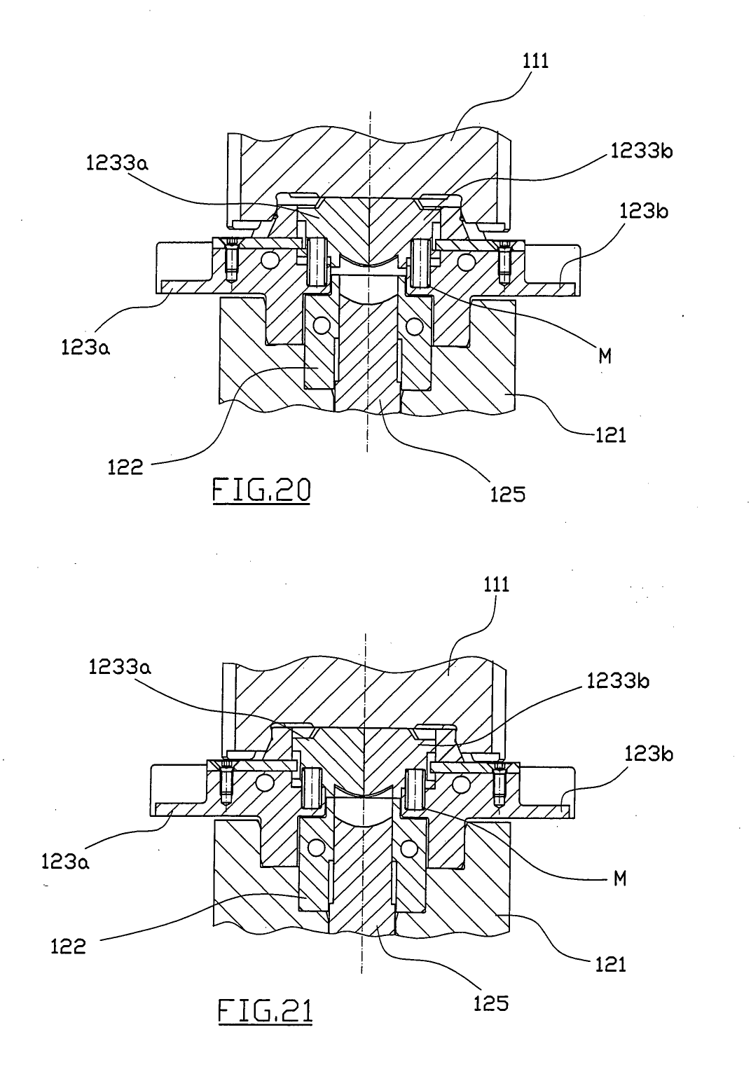

FIGS. 17 to 19 show a closure 300 made up of a capsule 301 intended to be fixed, in a known way, to the neck of a bottle or flask.

### BEST MODE FOR CARRYING THE INVENTION

The capsule 301 has a dispensing hole 302, and is connected by a flap 303 to the lid 304.

The lid 304 has a small cap 305 suitable for fitting together with the dispenser 302.

As can be seen more clearly in FIGS. 18 and 19 the flap 303 is arched in two directions to take up a bi-stable position, in other words to place the lid in a stably open position or in a stably closed position (not illustrated).

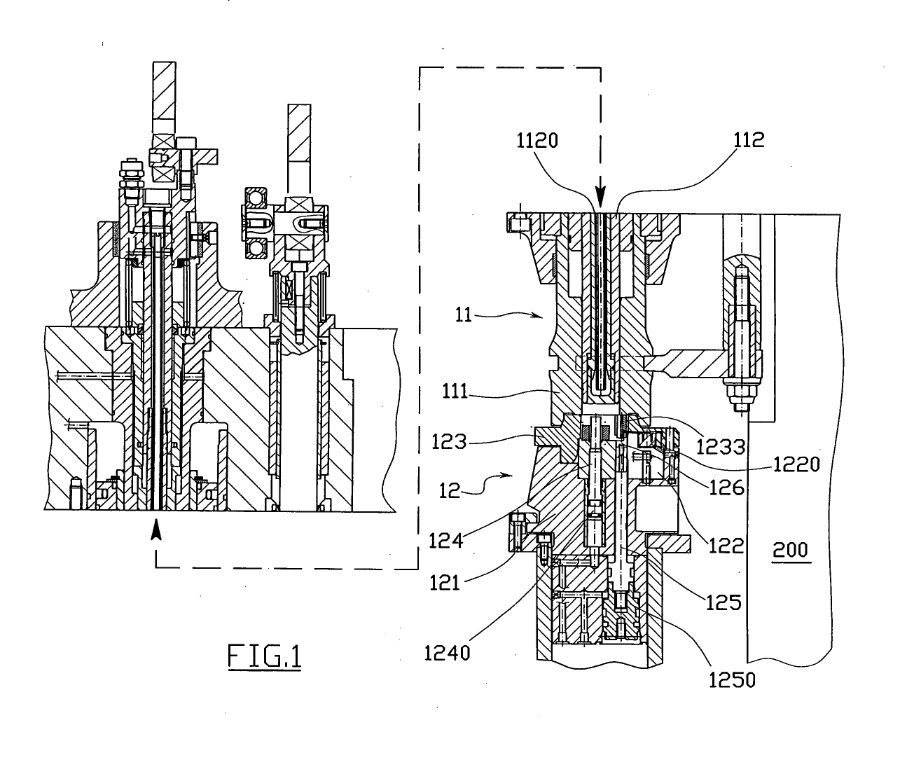

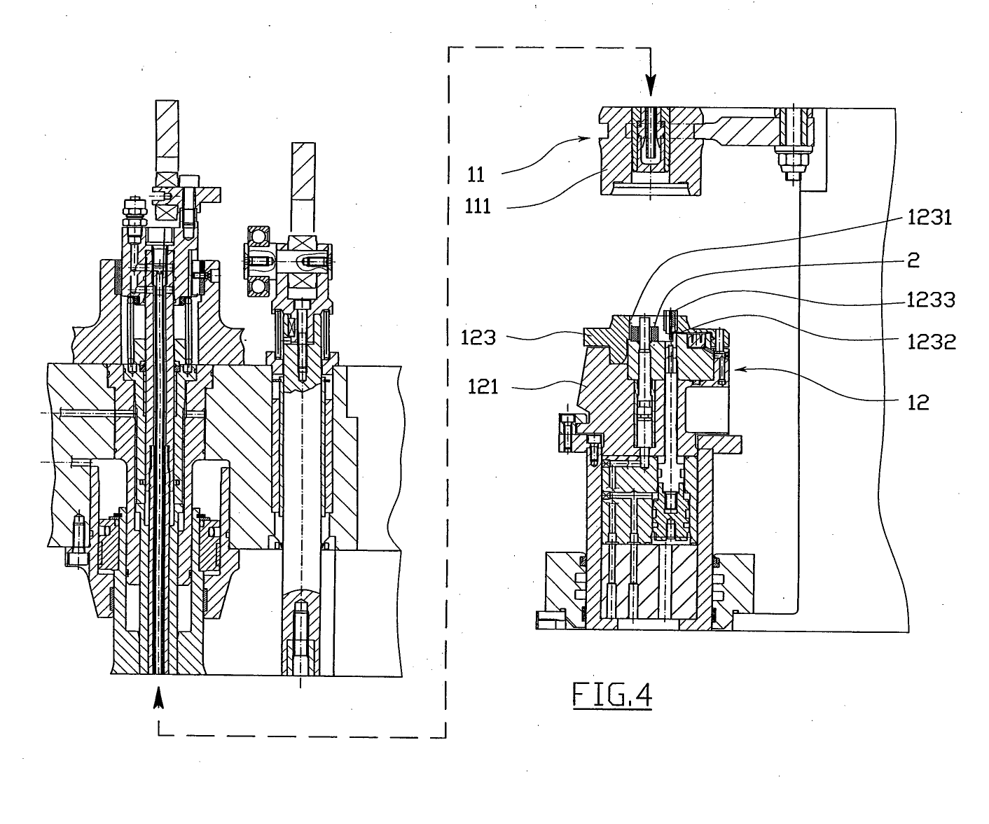

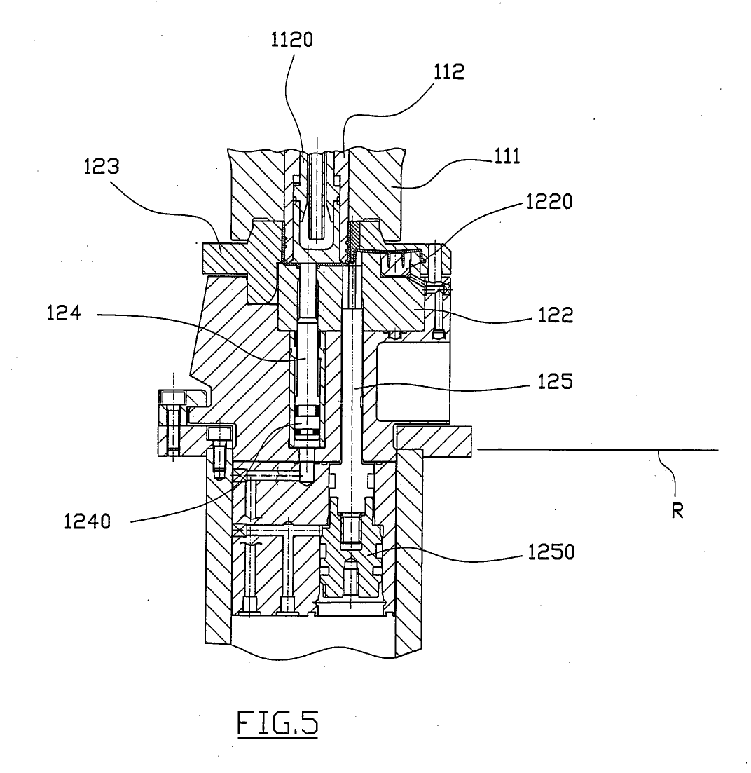

From FIGS. 1 to 16 it is possible to see a mould intended for the compression-moulding of a dose 2 of thermoplastic synthetic material preferably selected from those commonly used for the moulding of closure capsule. The mould, see FIG. 4, is made up of a top part 11 comprising the cylindrical body 111 in which the first plunger 112 slides and a bottom part 12 that provides the forming recess.

The plunger 112 has an inner part 1120 that can slide independently of the outer part, which has the task of making it easier to pull the item out from the mould as shall be seen hereafter.

Both of the parts 11 and 12 are equipped with movements towards and away from each other that shall be explained more clearly hereafter.

The bottom part 12 comprises a block 121 that carries a plate 122 on top that makes the bottom surface of the recess moulding.

The plate 122 comprises a porous insert 1220 intended to form the cap-shaped portion 305 of the item, said insert being in communication with a feed of pressurised fluid intended to make it easier to remove the item from the mould.

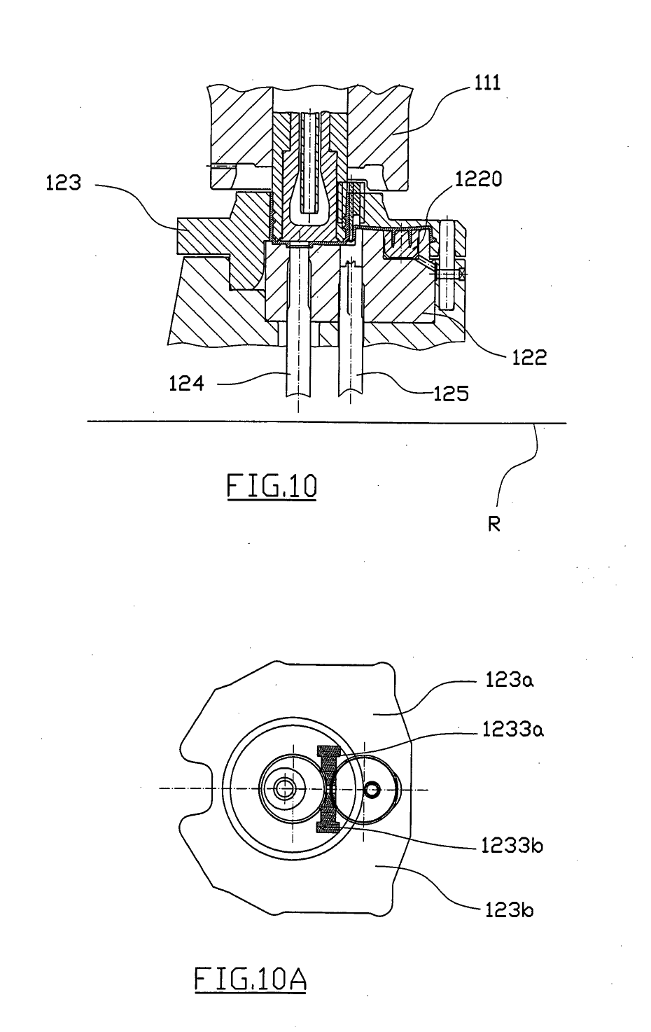

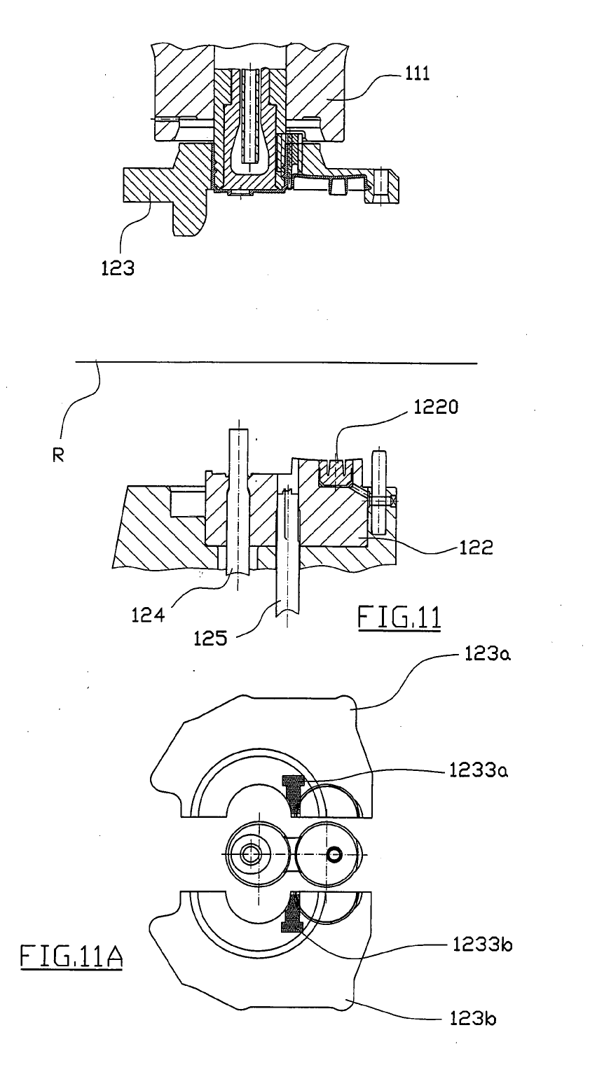

The moulding recess is defined as a whole by the plate 122 and by a top collar 123 made up of two parts 123a and 123b that are arranged to fit together as indicated (FIG. 10A), or else move apart (FIG. 11A).

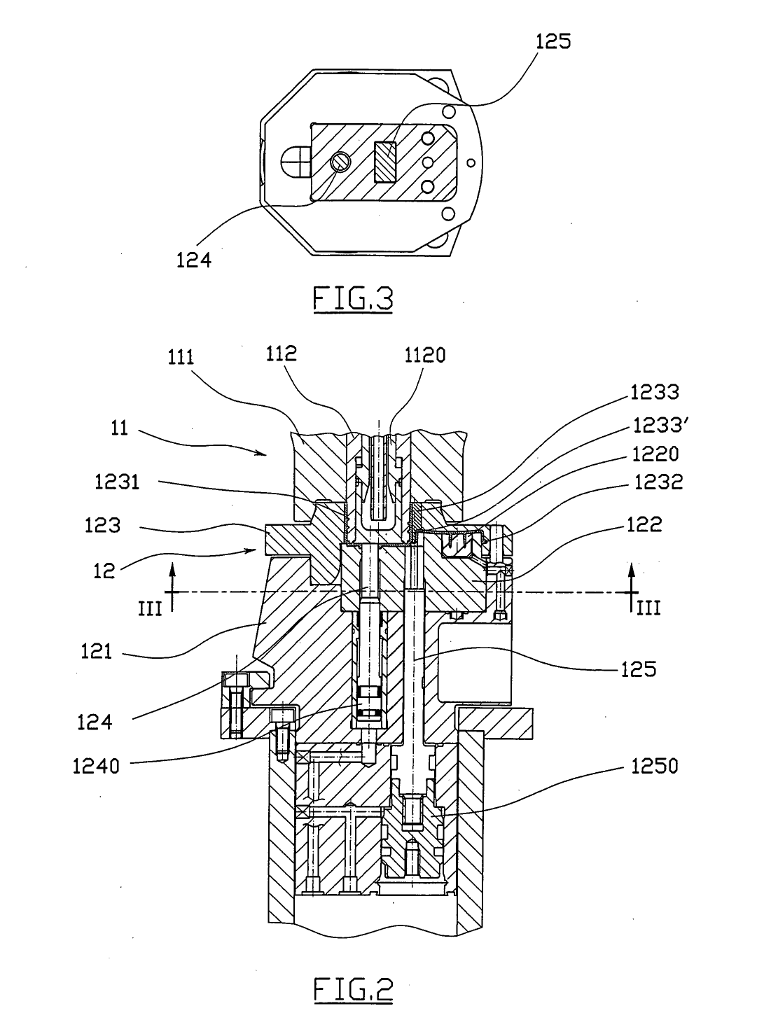

Through holes in the plate 122 and in the block 121 (FIG. 2 and FIG. 3) a first plug 124 and a second plug 125 project, also called secondary plunger, respectively actuated by two pneumatic pistons 1240 and 1250.

The plug 124 and the second plunger 125, with the mould closed, are in the position illustrated in FIG. 2, whereas with the mould open they are in the position illustrated in FIG. 4.

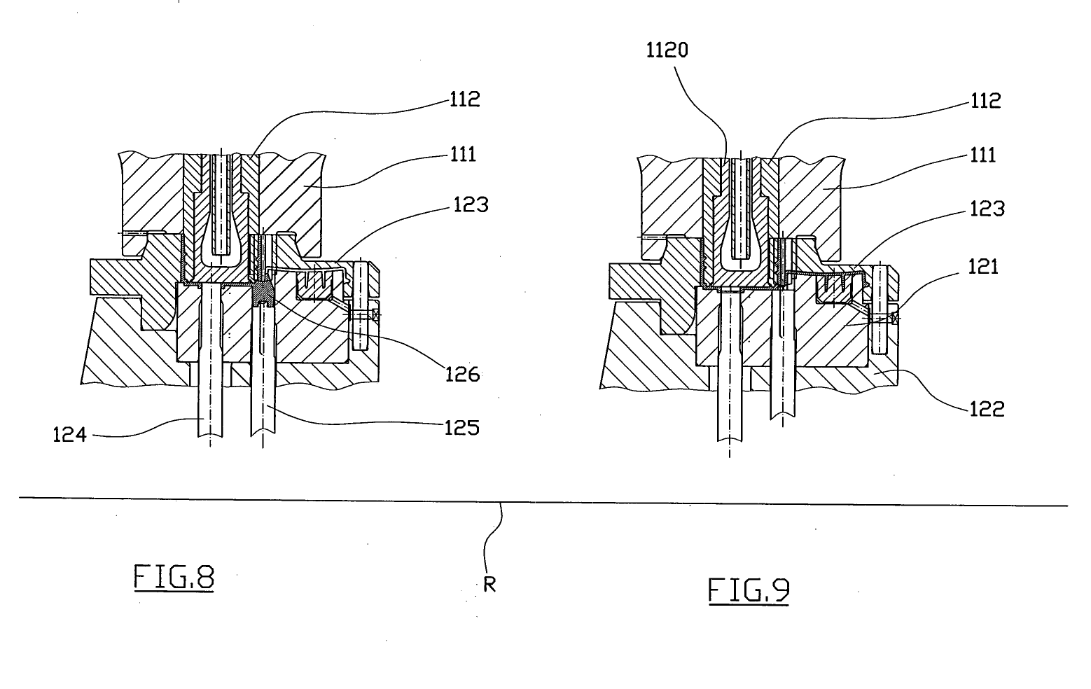

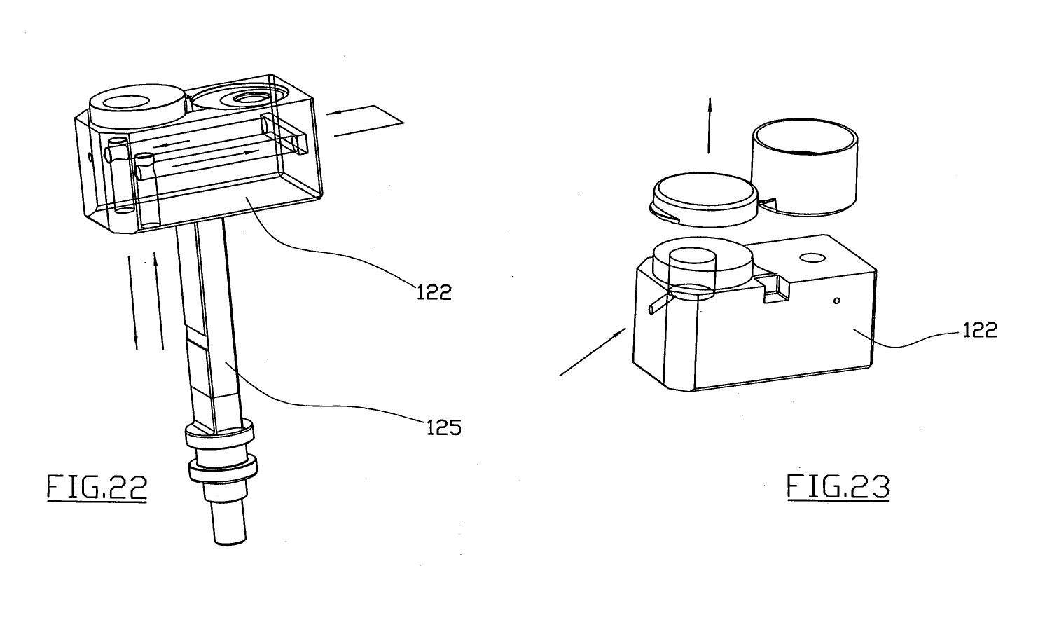

In particular, when the mould is closed the top end of the second plunger 125 coincides with the bottom surface of the forming recess, and the first plug 124 rests against the base of the part 1120 that is inside the plunger 112, whereas when the mould is open (FIG. 4) the first plug 124 goes up in the forming recess, whereas the second plunger 125 goes down inside the plate 122 until it provides an accumulation chamber 126 the function of which shall be made clearer later on (see FIGS. 7 and 8). The plate containing the accumulation chamber is thermoregulated through normal means (FIG. 22) that shall not be described, so as to ensure the desired characteristics of slidability and formability of the material.

The collar 123, when its two parts 123a and 123b are fitted together, provides a first cylindrical recess 1231 open both upwards and downwards, adjacent to a second upwardly blind cylindrical recess 1232.

Between the parts 123a and 123b of the collar 123, in an intermediate position to the two cylindrical recesses, the sliding seat for a second shaped top flap 1233 (see FIG. 2, FIG. 10A and FIG. 11A) is created, made up of two parts 1233a and 1233b that respectively remain integral with the parts 123a and 123b of the collar when it opens. The second flap defines a portion of the forming recess and has an appendix 1233′ at the bottom suitable for limiting at the top the port in which the hinge of the closure shall be formed.

The two parts of the second flap 1233 are able to slide axially against the action of a spring, and are pushed into the forming position by the cylindrical body 111 of the top part of the mould.

The cylindrical body 111, when it is in work position (FIG. 2), embraces the outside of the collar 123, and keeps the two parts 123a and 123b of the collar held together and pressed in contact with the body 121.

Inside the body 111 slides the forming plunger 112 which, when the mould is closed, takes up the position of FIG. 2 inside the forming recess, whereas with the mould open it takes up the position of FIG. 4, withdrawn for a part inside the cylindrical body 111.

The device described above is one of a plurality of identical devices supported equidistant from a carousel 200 rotating on a fixed base that is not illustrated.

All of the devices are moved by cams integral with the fixed base or else by fluid dynamic devices that are not described since they are of a type well known the men skilled in the art, and easy to make according to the movement of the various parts described hereafter.

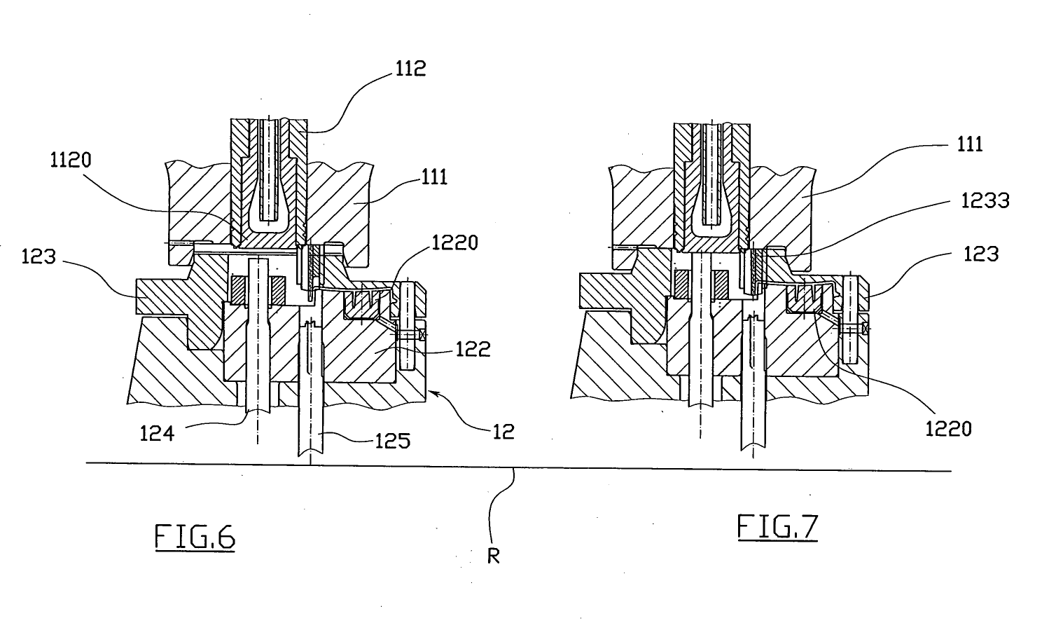

The operation of the device shall be explained hereafter with the help of FIGS. 6 to 16.

The configuration of the mould at the start of the cycle is that shown in FIG. 4.

With the mould in this configuration, a dose 2 of synthetic material preferably having the shape of a doughnut is arranged inside the mould; the dose can also be shaped differently, for example U-shaped or other.

In particular, the dose, if doughnut-shaped or U-shaped, is slotted in at the top of the first flap 124 projecting inside the forming chamber.

The dose is introduced through means known in the field of compression-moulding of capsules, these means not being described here in detail.

When the dose 2 has been inserted, the part 12 begins to go up towards the part 11 until it places the collar 123 in contact with the body 111, after which the cylindrical body 111 also goes up until it places the plunger 112 roughly flush with its bottom surface (FIG. 6).

The rise of the part 12 continues until the cylindrical body 111 abuts against the collar 123, also locking in position the two parts of the shaped flap 1233 that defines the forming chamber at the top in the part that concerns the hinge 303 of the closure, as illustrated in FIG. 7.

At this point (FIG. 8) the rise of the part 12 brings about the introduction of the plunger 112 into the recess of the mould and the dose begins to occupy the interspace that is being created between the plunger 112, the collar 123 and the plate 122.

The flap 124 goes down elastically pushed by the plunger, creating the hole of the dispenser 302 in the body of the capsule 301, and the second plunger 125 remains in lowered position leaving free the accumulation chamber 126 in which flows a portion of the dose that encounters less resistance than that required to fill the part of interspace relative to the lid 304 of the closure, on the right in the figures.

The subsequent step (FIG. 9) involves the second plunger 125 rising, pushing the portion of dose contained in the accumulation chamber 126 to fill the remaining part of interspace completing the forming of the item.

The second plunger develops a push on the plastic material such as to complete the correct filling of the forming chamber to ensure the correct thickness of the hinge part.

The portion of the item that must have a thickness strictly designed is the hinge 303.

Possible compensations of the amount of material in excess or deficient to the nominal amount are carried out in the thickness of the bottom of the portion 301 of the item, whereas the thicknesses of the portion 304 are precise.

It should be specified that the second plunger 125 rises exactly by the amount necessary to determine the desired thickness of the overlying portion of the forming interspace intended for the creation of the hinge 303, this being taken care of by a stop of the respective actuation piston 1250, as well as by the second flap 1233 resting against the body 111.

Once the forming of the item is complete, the secondary plunger 125 goes back down (FIG. 10) and the entire bottom part 12 of the mould goes back down to the position of FIG. 4 (FIG. 11).

At the same time as the collar 123 moves away from the body 111, the second flap 1233, in the two parts 1233a and 1233b, rises elastically going into rest position, and withdrawing the hinge that is, as in FIG. 19, curved also in the direction of the separation of the collar 123.

The descent of the bottom part 12 detaches the body 111 from the underlying two parts 123a and 123b of the collar 123 that separate (FIG. 11A) together with the parts 1233a and 1233b, going down and leave the article free as illustrated in FIG. 12.

The withdrawal of the item is thus completed.

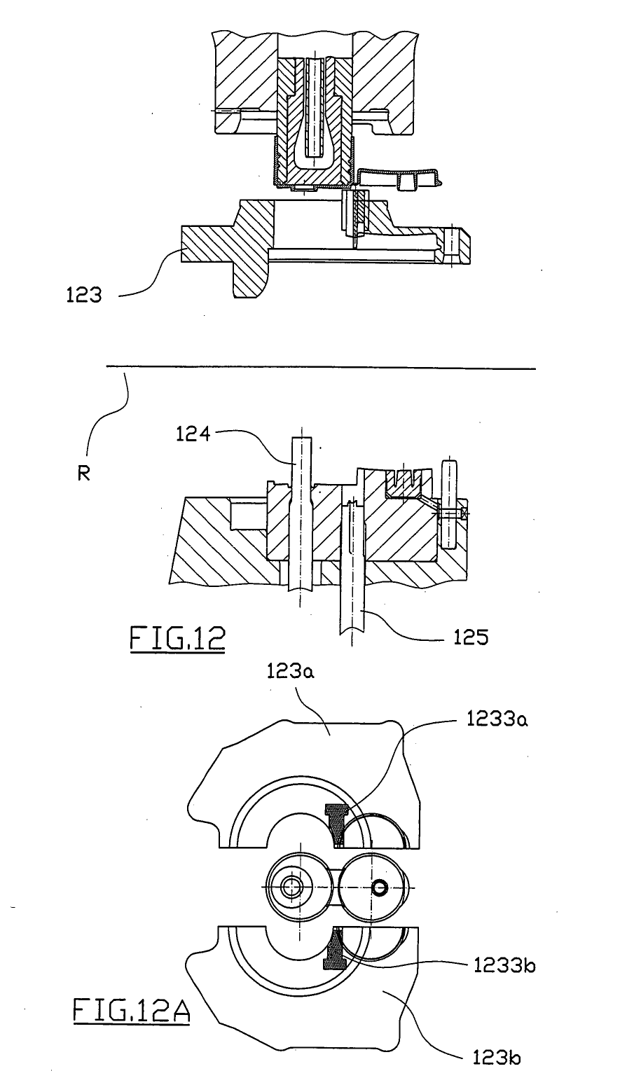

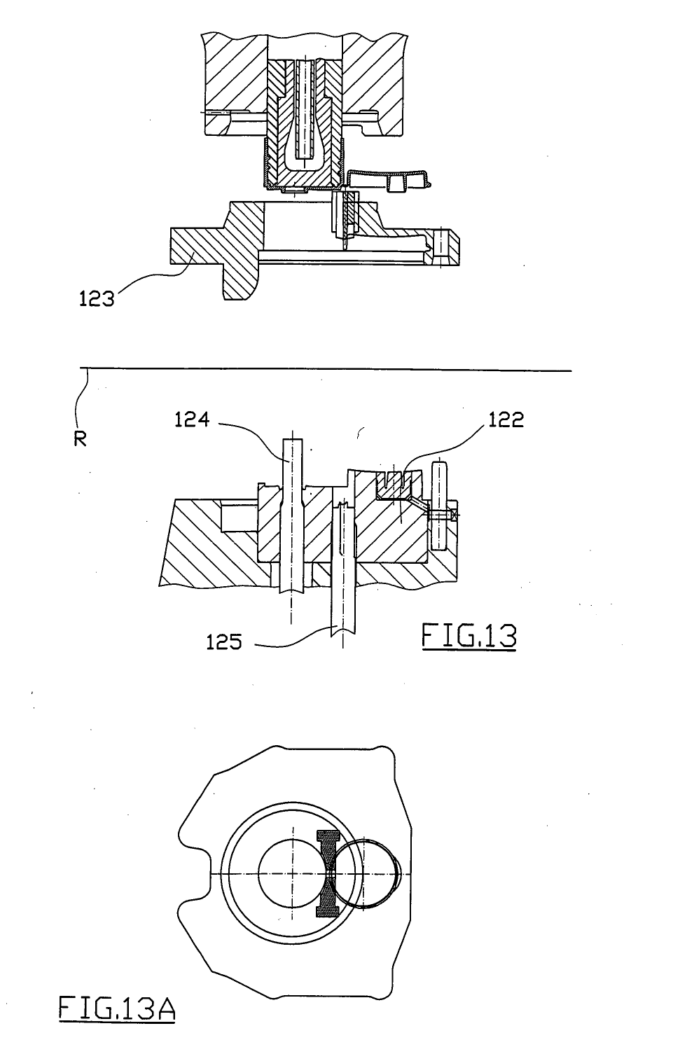

Thereafter, the collar 123 is put back together (FIG. 13, 13A) and the collar goes back down again to go into contact with the body 121 (FIG. 14).

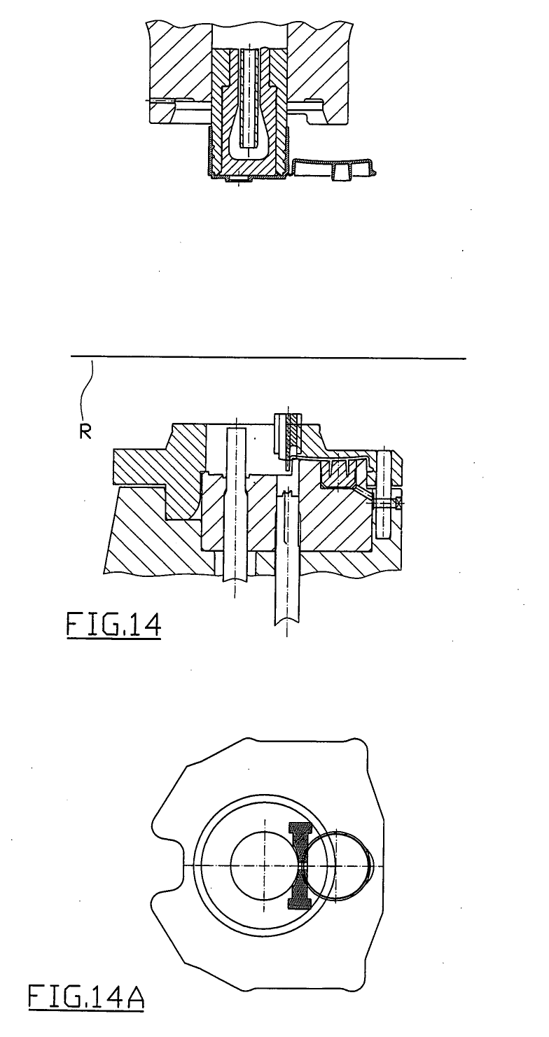

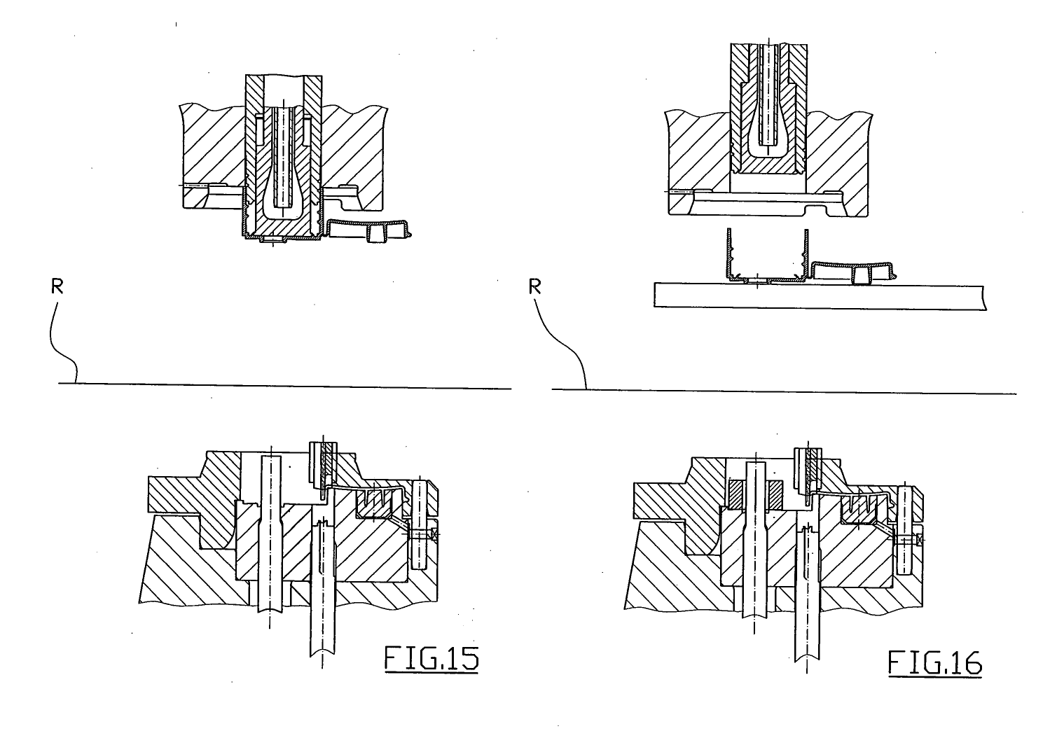

The definitive pulling away of the piece (FIGS. 15 and 16) is helped by the relative downwards displacement of the parts 111 and 1120 relative to the plunger 112.

Withdrawal is also made easier by the assistance of pressurised fluids, which feed channels that have not been illustrated for the sake of simplicity, which extend within the parts 11 and 12.

In particular, this takes place at the cap 305 of the lid of the item, formed by the porous insert 1220.

A possible configuration of the channels for the thermoregulation of the plate 122 is shown in FIG. 22.

1. Method for forming an item through compression-moulding having an asymmetrical section with differentiated volumes and thicknesses, comprising the steps of introducing a dose of semi-liquid resin into the recess of a mould, inserting a plunger in said recess to create the interspace intended to be occupied by the material pushed by the plunger, removing said plunger and withdrawing the item that stays stuck to the plunger or to the recess, characterised in that the interspace intended for the forming of the item is created in two successive steps, the first comprising the insertion of a first plunger into the recess, and the second comprising the action of C!-second plunger that acts in a portion (accumulation chaffiber) of the interspace created by the insertion of the first plunger, completing the creation of the interspace in which the item is formed.

2. Method according to claim 1, characterised in that the volume of the accumulation chamber is reduced to zero by the action of the additional plunger.

3. Method according to claim 1, characterised in that the additional plunger defines the portion of the interspace intended for forming the portion of item with thinner section.

4. Method according to claim 1, characterised in that the temperature of the material at least in the accumulation chamber is thermostatically maintained at the desired value according to the material used to ensure its slidability and formability under compression.

5. Mould for the compression-moulding of an item having two portions of different volume connected by a portion with thinner section, characterised in that it comprises a forming interspace defined, in collaboration with the recess of the mould, by a first plunger that is introduced into the recess of the mould, and by a second plunger that is introduced into an accumulation chamber communicating with the recess of the mould.

6. Mould according to claim 5, characterised in that said accumulation chamber and said second plunger are arranged at the portion of interspace with thinner thickness intended to connect two parts of interspace having different volume.

7. Mould according to claim 5, characterised in that the recess of the mould is defined by a base plate, by an overlying portion or collar rested on the base plate and having at least one through recess in which the first plunger slides, and by an accumulation chamber formed in the plate, in which the second plunger slides.

8. Mould according to claim 7, characterised in that the accumulation chamber is arranged in communication with the portion of the recess of the mould intended to form the thinner portion of the item, which separates two portions of different volume.

9. Mould according to claim 8, characterised in that the portion of the recess of the mould intended to form the thinner portion of the item separates two portions of the forming recess of equal volume.

10. Mould according to claim 7, characterised in that the accumulation chamber comprises means suitable for keeping the temperature at the desired value according to the quality of the material.

11. Mould according to claim 7, characterised in that the portion or collar lying above the base plate is made up of two halves that are arranged to fit together or else move apart to promote the withdrawal of the item, which are held together by the overlying cylindrical body that contains the plunger.

12. Mould according to claim 11, characterised in that the collar comprises a recess arranged straddling the joining plane of the two halves, in which slides a flap also made up of two halves each suitable for staying engaged with one of the halves of the collar, said flap being elastically pushed upwards and fitting into the collar when it comes into contact with the cylindrical body that contains the plunger.

13. Mould according to claim 5, characterised in that the first plunger comprises two coaxial parts that are mobile independently of each other.

14. Mould according to claim 7, characterised in that the base plate comprises a porous insert suitable for forming a portion of the item, communicating with a feeding duct of compressed air.

15. Mould according to claim 7, characterised in that the base plate and the first plunger comprise pneumatic means for making it easier to pull away the item.

16. Mould according to claim 13, characterised in that it comprises independent means for moving the cylindrical body, the two parts of the first plunger, the base plate, the collar and the second plunger, according to the axis of the recess of the mould.

17. Mould according to claim 7, characterised in that the plate is crossed by a first flap kept elastically pressed against the base of the first plunger during the forming of the material, to create a hole in the moulded item.

18. Mould according to claim 11, characterised in that the two parts of the collar create between them the seat for a second shaped flap, also made up of two parts that remain integral with the respective parts of the collar, said flap constituting a portion of the recess in which the thinner part of the item shall be formed.

19. Mould according to claim 18, characterised in that the two parts of the second flap can slide integrally in the seat, against the action of a spring, and are pushed into the forming position by the cylindrical body of the top part of the mould.
